(19) United States
(12) Patent Application Publication
(10) Pub. No.: US 2021/0234493 A1
(43) Pub. Date: Jul. 29, 2021

(54) MOTOR DEVICE, CONTROLLER, MOTOR SYSTEM, FAN UNIT, AND COMMUNICATION METHOD

(71) Applicant: Panasonic Intellectual Property Management Co., Ltd., Osaka-shi, Osaka (JP)

(72) Inventors: Shinsuke Kimura, Kyoto (JP); Mitsuhiro Sakamoto, Osaka (JP)

(73) Assignee: Panasonic Intellectual Property Management Co., Ltd., Osaka-shi, Osaka (JP)

(21) Appl. No.: 17/257,116

(22) PCT Filed: Jun. 21, 2019
(86) PCT No.: PCT/JP2019/024621

§ 371 Date: Dec. 30, 2020

(30) Foreign Application Priority Data
Jul. 6, 2018 (JP) 2018-128879

(51) Int. Cl. H02P 29/024; H02P 6/28

(52) U.S. Cl. CPC H02P 29/024; H02P 6/28

(57) ABSTRACT

A motor device includes a motor and a processing unit to control the motor. The processing unit transmits a current signal to a controller, which is electrically connected to the motor, by causing a current to flow through windings of the motor.

### TECHNICAL FIELD

The present disclosure generally relates to a motor device, a controller, a motor system, a fan unit, and a communication method, and more particularly relates to a motor device with communication capability and a controller, a motor system, a fan unit, and a communication method.

### BACKGROUND ART

Patent Literature 1 discloses a motor which is programmable about settings of the rotational direction and velocity, for example, of the motor. The motor of Patent Literature 1 includes a sensor for sensing the frequency of an alternating current applied by a controller. When the frequency of the alternating current applied falls out of a normal frequency range of an alternating current, the motor switches to a programming mode. Then, the motor detects a variation in the frequency of the alternating current applied as programming data.

The motor (motor device) of Patent Literature 1 notifies the user either visually or aurally, by vibrating or rotating the motor, that the programming is completed.

However, if it is difficult for the motor device of Patent Literature 1 to rotate the motor, then the user cannot confirm that the programming is completed, i.e., that the motor device has safely received a communications signal from the controller. This is a problem with the motor device of Patent Literature 1. In addition, in the motor device of Patent Literature 1, if the user cannot see the motor rotate or cannot hear the vibration sound of the motor, then the user cannot confirm that the motor device has received the communication signal from the controller. This is another problem with the motor device of Patent Literature 1. That is to say, in the motor device of Patent Literature 1, if the user cannot confirm the operation of the motor either visually or aurally, then he or she cannot gain the information provided by the motor device.

### CITATION LIST

### Patent Literature

Patent Literature 1: US 2013/0234630 A1

### SUMMARY OF INVENTION

It is therefore an object of the present disclosure to provide a motor device, a controller, a motor system, a fan unit, and a communication method, all of which are configured or designed to allow, even when the user cannot confirm the operation of a motor either visually or aurally, him or her to gain the information provided by the motor device.

A motor device according to an aspect of the present disclosure includes a motor and a processing unit to control the motor. The processing unit transmits a current signal to a controller, which is electrically connected to the motor, by causing a current to flow through windings of the motor.

A controller according to another aspect of the present disclosure is electrically connected to the motor device described above and receives the current signal transmitted from the motor device.

A motor system according to still another aspect of the present disclosure includes the motor device described above and a controller. The controller is electrically connected to the motor device and receives the current signal transmitted from the motor device.

A fan unit according to yet another aspect of the present disclosure includes a blade to be attached to the motor of the motor device and turns the blade on receiving force produced by the motor.

A communication method according to yet another aspect of the present disclosure is a method for establishing communication between a controller and a motor device including a motor. The communication method includes transmitting a current signal to a controller, which is electrically connected to the motor, by causing a current to flow through windings of the motor.

### BRIEF DESCRIPTION OF DRAWINGS

FIG. 1 is a circuit diagram schematically illustrating a motor system including a motor device and controller according to an exemplary embodiment of the present disclosure;

FIG. 2 is a circuit diagram schematically illustrating the controller;

FIG. 3 is a circuit diagram schematically illustrating the motor device to which a power supply is connected;

FIG. 4 schematically illustrates an exemplary use of a fan unit including the motor device;

FIGS. 5A and 5B illustrate how the motor device operates in a communication mode;

FIG. 6A is a waveform chart showing an exemplary current flowing through windings of the motor device;

FIG. 6B is a waveform chart showing an exemplary current flowing through a detection resistor in the motor device;

FIG. 7A is a waveform chart showing an exemplary current flowing through a detection resistor in the controller;

FIG. 7B is a waveform chart showing an exemplary voltage signal output from a detection unit in the controller;

FIG. 7C is a waveform chart showing an exemplary digital signal received as a current signal by the controller;

FIG. 8A is a waveform chart showing an exemplary current flowing through a winding in the motor device;

FIG. 8B is a waveform chart showing an exemplary voltage signal output from a detection unit in the controller; and

FIG. 8C is a waveform chart showing an exemplary digital signal received as a current signal by the controller.

### DESCRIPTION OF EMBODIMENTS

(1) Configuration

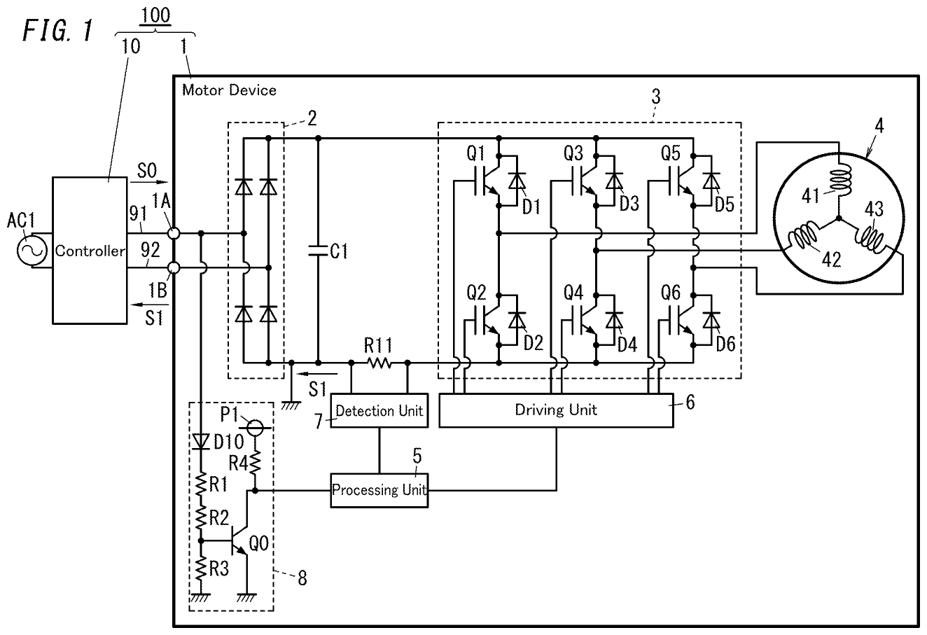

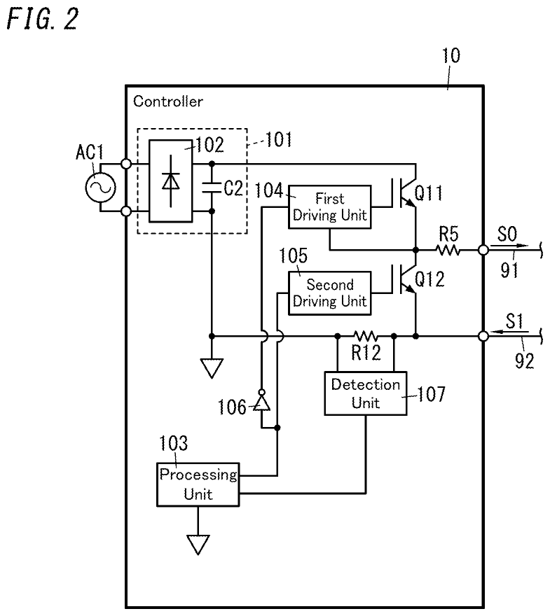

A motor device 1, controller 10, and motor system 100 according to an exemplary embodiment of the present disclosure will now be described. As shown in FIGS. 1 and 2, the motor system 100 includes the motor device 1 and the controller 10. The motor device 1 includes a motor 4 and a circuit for driving the motor 4. The controller 10 is configured to be electrically connectable to the motor device 1 and includes a circuit for transmitting a communication signal S0 to the motor device 1. The communication signal S0 may include data or a command for changing the settings of the motor device 1. In addition, the controller 10 may also have the capability of receiving a current signal S1 (to be described later) transmitted from the motor device 1.

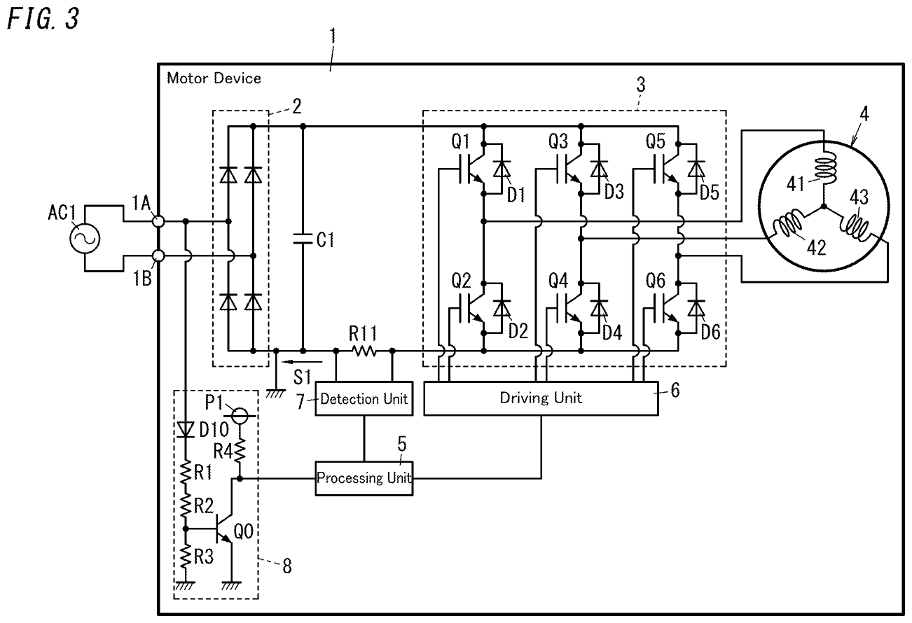

According to this embodiment, there may arise two situations, namely, a situation where a power supply AC1 is connected to the motor device 1 (see FIG. 3) and a situation where the controller 10 is connected to the motor device 1 (see FIG. 1). The motor system 100 is formed when the controller 10 is connected to the motor device 1. The power supply AC1 is an AC power supply, which may be a commercial power supply, for example.

As shown in FIGS. 1 and 3, the motor device 1 includes a pair of input terminals 1A, 1B, a rectifier circuit 2, an inverter circuit 3, the motor 4, a processing unit 5, a driving unit 6, a detection unit 7, and a reception unit 8. The motor device 1 further includes a capacitor C1 and a detection resistor R11. Either the controller 10 or the power supply AC1 is electrically connected to the pair of input terminals 1A, 1B through a pair of electric cables 91, 92. Note that the pair of input terminals 1A, 1B does not have to be terminals as parts to which the electric cables are connected, but may also be leads of an electronic part or parts of a conductor included in a circuit board, for example.

The rectifier circuit 2 is a circuit for rectifying the voltage applied to the pair of input terminals 1A, 1B (hereinafter referred to as an “input voltage”). In this embodiment, the rectifier circuit 2 is implemented as a diode bridge. Therefore, in this embodiment, the rectifier circuit 2 full-wave rectifies the input voltage. Thus, if the input voltage is AC voltage, the rectifier circuit 2 outputs a pulsating voltage by full-wave rectifying the AC voltage. On the other hand, if the input voltage is DC voltage, then the rectifier circuit 2 outputs the input voltage without full-wave rectifying the input voltage (i.e., outputs the DC voltage as it is).

The capacitor C1 is electrically connected to a pair of output terminals of the rectifier circuit 2 and a pair of input terminals of the inverter circuit 3. The capacitor C1 is implemented as a smoothing capacitor, which smooths out the output voltage (pulsating voltage) of the rectifier circuit 2. Thus, the voltage across the capacitor C1 (DC voltage) is applied to the pair of input terminals of the inverter circuit 3.

The inverter circuit 3 is a so-called “three-phase inverter” and includes six switching elements Q1-Q6. In this embodiment, each of the switching elements Q1-Q6 is implemented as an insulated gate bipolar transistor (IGBT). Between the collector and emitter of these switching elements Q1-Q6, commutation diodes D1-D6 are electrically connected, respectively. The respective collectors of the switching elements Q1, Q3, Q5 are all electrically connected to a first terminal of the capacitor C1 (i.e., the high-potential output terminal of the rectifier circuit 2). The respective emitters of the switching elements Q2, Q4, Q6 are all electrically connected to a second terminal of the capacitor C1 (i.e., the low-potential output terminal of the rectifier circuit 2) via the detection resistor R11. The emitter of the switching element Q1 and the collector of the switching element Q2 are both electrically connected to a first terminal of a first winding 41 (to be described later) of the motor 4. The emitter of the switching element Q3 and the collector of the switching element Q4 are both electrically connected to a first terminal of a second winding 42 (to be described later) of the motor 4. The emitter of the switching element Q5 and the collector of the switching element Q6 are both electrically connected to a first terminal of a third winding 4 (to be described later) of the motor 4. The respective second terminals of the first winding 41, the second winding 42, and the third winding 43 are electrically connected together at a neutral point. The respective gates of the switching elements Q1-Q6 are all electrically connected to the driving unit 6.

The driving unit 6 serves as a driver for the switching elements Q1-Q6. The driving unit 6 is controlled by the processing unit 5, thereby outputting a drive signal to the respective gates of the switching elements Q1-Q6. The switching elements Q1-Q6 switch their ON/OFF states in accordance with the drive signal supplied from the driving unit 6.

The inverter circuit 3 is controlled by the processing unit 5 via the driving unit 6. In this embodiment, when the processing unit 5 operates in a normal mode (to be described later), the inverter circuit 3 converts the input DC voltage into AC voltage and applies the AC voltage thus converted to the windings 41, 42, 43, thereby supplying an alternating current to the windings 41, 42, 43. In other words, the inverter circuit 3 converts an input current into an alternating current and supplies the alternating current to the windings 41, 42, 43. On the other hand, when the processing unit 5 operates in a communication mode (to be described later), the inverter circuit 3 supplies a direct current to the windings 41, 42, 43.

The motor 4 is a synchronous motor and may be implemented as a so-called “brushless direct current (DC) motor.” The motor 4 includes three windings 41, 42, 43 which are connected together in a Y connection (star connection) pattern and which will be hereinafter referred to as a “first winding 41,” a “second winding 42,” and a “third winding 43,” respectively. The motor 4 is configured to be driven by having a current (phase current) supplied to each of multiple different phases (namely, U, V, and W phases). In this embodiment, a U-phase current flows through the first winding 41, a V-phase current flows through the second winding 42, and a W-phase current flows through the third winding 43.

The processing unit 5 may be implemented as, for example, a computer (including a microcomputer) including, as major constituent elements, a processor and a memory. That is to say, the processing unit 5 is implemented as a computer system including a processor and a memory. The computer system performs the function of the processing unit 5 by making the processor execute an appropriate program. The program may be stored in advance in the memory. Alternatively, the program may also be downloaded via a telecommunications line such as the Internet or distributed after having been stored in a non-transitory storage medium such as a memory card. Operating power for the processing unit 5 may be generated by making a power supply circuit that the motor device 1 includes convert the power supplied from either the power supply AC1 or the controller 10 into predetermined power.

The operation modes of the processing unit 5 include a normal mode in which the processing unit 5 drives the motor 4 and a communication mode in which the processing unit 5 communicates with the controller 10. The normal mode is an operation mode when the power supply AC1 is connected to the motor device 1. The communication mode is an operation mode when the controller 10 is connected to the motor device 1.

When the operation mode is the normal mode, the processing unit 5 reads out operation data stored in the memory and controls the driving unit 6 based on the operation data that has been read out, thereby controlling the switching elements Q1-Q6 of the inverter circuit 3. In this manner, the processing unit 5 controls the motor 4 in accordance with the operation data. The operation data may include various parameters about the operation of the motor 4 such as the rotational direction and velocity of the motor 4 and acceleration thereof.

When the operation mode is the communication mode, the processing unit 5 receives the communication signal S0 transmitted from the controller 10 and updates the operation data stored in the memory in accordance with the data or command included in the communication signal S0 received. According to this embodiment, the motor device 1 is able to rewrite the operation data of the motor 4 by using the controller 10. In addition, in the communication mode, the processing unit 5 transmits a current signal S1 to the controller 10 that is electrically connected to the motor 4 by controlling the inverter circuit 3 to cause a current to flow through the windings 41, 42, 43 of the motor 4. In this embodiment, the processing unit 5 transmits the current signal S1 in response to the communication signal S0 transmitted from the controller 10. In particular, in this embodiment, the processing unit 5 transmits the current signal S1 when safely receiving the communication signal S0 from the controller 10. That is to say, in this embodiment, it is not until the controller 10 transmits the communication signal S0 that the processing unit 5 transmits the current signal S1. It will be described in detail later in the “(2) Operation” section exactly how the motor device 1 transmits the current signal S1.

The detection unit 7 detects a current flowing through the detection resistor R11 by detecting the voltage across the detection resistor R11. In this embodiment, the detection resistor R11 is electrically connected between a second terminal of the capacitor C1 (i.e., the low-potential terminal of the rectifier circuit 2) and the low-potential input terminal of the inverter circuit 3. Also, if the current signal S1 has been generated in the communication mode, the current flowing through the windings 41, 42, 43 of the motor 4 flows through the detection resistor R11. That is to say, the detection unit 7 detects the current flowing through the windings 41, 42, 43. Then, the detection unit 7 outputs the result of detection to the processing unit 5.

The reception unit 8 is a voltage step-down circuit, which receives the communication signal S0 supplied to the pair of input terminals 1A, 1B and outputs the communication signal S0 to the processing unit 5. In this embodiment, the communication signal S0 is a voltage signal as will be described later. Thus, the reception unit 8 receives a voltage signal as the communication signal S0 and outputs the voltage signal to the processing unit 5. The reception unit 8 includes a diode D10, four resistors R1-R4, and a switching element Q0. The anode of the diode D10 is electrically connected to the high-potential input terminal 1A, out of the pair of input terminals 1A, 1B. Between the cathode of the diode D10 and a reference potential (e.g., ground in this example), three resistors R1-R3 are electrically connected together in series. The three resistors R1-R3 together form a voltage divider circuit for dividing the voltage applied between the pair of input terminals 1A, 1B. The switching element Q0 may be implemented as, for example, an NPN bipolar transistor. The emitter of the switching element Q0 is electrically connected to the reference potential. The base of the switching element Q0 is electrically connected to a connection point of the resistors R2, R3. The collector of the switching element Q0 is electrically connected to a power supply terminal P1 via a resistor R4, which is a pull-up resistor. In addition, the collector of the switching element Q0 is also electrically connected to a signal input terminal of the processing unit 5.

The switching element Q0 turns ON when the magnitude of the voltage applied between the pair of input terminals 1A, 1B exceeds a predetermined value and turns OFF when the magnitude of the voltage applied between the pair of input terminals 1A, 1B becomes equal to or less than the predetermined value. That is to say, the switching element Q0 switches its ON/OFF states in accordance with a voltage signal (i.e., the communication signal S0). If the switching element Q0 is ON, a voltage corresponding to the reference potential is input to the processing unit 5. On the other hand, if the switching element Q0 is OFF, then a voltage corresponding to a terminal voltage of a power supply terminal P1 is input to the processing unit 5.

That is to say, while a DC voltage is being applied between the pair of input terminals 1A, 1B, a zero voltage (reference voltage) is applied continuously to the processing unit 5. Also, if the voltage signal (communication signal S0) is input between the pair of input terminals 1A, 1B, the communication signal S0 is input to the processing unit 5. That is to say, in that case, a binary signal (digital signal) that may have one of two values, namely, a high level (i.e., a terminal voltage of the power supply terminal P1) and a low level (i.e., the reference potential), is input as the communication signal S0 to the processing unit 5 according to the ON/OFF state of the switching element Q0.

In this embodiment, the processing unit 5 switches the operation mode to either the normal mode or the communication mode by monitoring the output voltage of the reception unit 8. Specifically, if the power supply AC1 is connected to the motor device 1, an AC voltage with a frequency of 50 Hz or 60 Hz is applied between the pair of input terminals 1A, 1B. Thus, the output voltage of the reception unit 8 is a pulse voltage with a frequency of 50 Hz or 60 Hz. On the other hand, if the controller 10 is connected to the motor device 1, a DC voltage will be applied continuously between the pair of input terminals 1A, 1B during the first certain period of transmission processing to be performed by the processing unit 103 of the controller 10 (to be described later). Thus, the output voltage of the reception unit 8 is the zero voltage.

Therefore, if the output voltage of the reception unit 8 is a pulse voltage, then the processing unit 5 switches the operation mode to the normal mode. On the other hand, if the output voltage of the reception unit 8 remains a zero voltage for a certain period, then the processing unit 5 switches the operation mode to the communication mode. As can be seen, according to this embodiment, the processing unit 5 determines, based on the waveform of the output voltage of the reception unit 8, whether or not the controller 10 is connected.

As shown in FIG. 2, the controller 10 includes a DC power supply 101, a processing unit 103, a first driving unit 104, a second driving unit 105, an inverter element 106, and a detection unit 107. The controller 10 further includes a current-limiting resistor R5, a detection resistor R12, and two switching elements Q11, Q12. Both of the two switching elements Q11, Q12 are insulated gate bipolar transistors (IGBTs).

The first driving unit 104 and the second driving unit 105 are drivers for driving the switching elements Q11, Q12, respectively, and may be implemented as high voltage ICs (HVICs). The inverter element 106 inverts a second drive signal supplied from the processing unit 103 to the second driving unit 105 and outputs the inverted second drive signal as a first drive signal to the first driving unit 104. That is to say, if the switching element Q11 is ON, then the switching element Q12 turns OFF. If the switching element Q11 is OFF, then the switching element Q12 turns ON. The current-limiting resistor R5 reduces an inrush current that may be generated when the controller 10 is started.

The controller 10 is a portable terminal that the user may carry with him or her, for example. As used herein, the user refers to a person who uses the controller 10. Examples of the users include a person who purchases the motor device 1 and a person who provides the motor device 1 for business.

The DC power supply 101 converts an AC voltage output from an AC power supply (such as the power supply AC1) connected to the controller 10 into a DC voltage and outputs the DC voltage thus converted. The DC power supply 101 includes a rectifier circuit 102 and a capacitor C2. The rectifier circuit 102 is a circuit for rectifying the AC voltage supplied from the AC power supply (i.e., the power supply AC1 in this example) and implemented as a diode bridge. Therefore, in this embodiment, the rectifier circuit 102 full-wave rectifies the input AC voltage. The capacitor C2 is electrically connected to a pair of output terminals of the rectifier circuit 102. The capacitor C2 is implemented as a smoothing capacitor, which smooths out the output voltage (pulsating voltage) of the rectifier circuit 102. Thus, the DC power supply 101 outputs the voltage across the capacitor C2 (i.e., a DC voltage).

The processing unit 103 may be implemented as, for example, a computer (including a microcomputer) including, as major constituent elements, a processor and a memory. That is to say, the processing unit 103 is implemented as a computer system including a processor and a memory. The computer system performs the function of the processing unit 103 by making the processor execute an appropriate program. The program may be stored in advance in the memory. Alternatively, the program may also be downloaded via a telecommunications line such as the Internet or distributed after having been stored in a non-transitory storage medium such as a memory card. Operating power for the processing unit 103 may be generated by making a power supply circuit that the controller 10 includes convert the power supplied from the power supply AC1 to predetermined power.

The processing unit 103 has the capability of generating a voltage signal by changing, in a predetermined pattern, the magnitude of voltage to be output from the controller 10 to the motor device 1 and transmitting, as the communication signal S0, the voltage signal thus generated to the motor device 1. In this embodiment, the processing unit 103 changes the magnitude of the output voltage of the controller 10 by controlling the first driving unit 104 and the second driving unit 105 to switch the ON/OFF states of the two switching elements Q11, Q12. Specifically, the processing unit 103 makes the controller 10 deliver the output voltage of the DC power supply 101 by turning the switching elements Q11, Q12 ON and OFF, respectively. In addition, the processing unit 103 also makes the pair of electric cables 91, 92 short-circuited with each other and set the output voltage of the controller 10 at zero by turning the switching elements Q11, Q12 OFF and ON, respectively.

That is to say, according to this embodiment, the communication signal S0 generated by the controller 10 is a voltage signal that may have one of the two values of high and low levels. As used herein, the “high level” corresponds to the magnitude of the output voltage of the DC power supply 101 and the “low level” corresponds to zero.

In this embodiment, the processing unit 103 transmits the communication signal S0, including data of multiple bits, to the motor device 1 on a bit-by-bit basis by changing the output voltage of the controller 10 in accordance with the data and command to transmit. That is to say, according to this embodiment, the type of communication between the processing unit 5 and the controller 10 is asynchronous serial communication.

Furthermore, according to this embodiment, the processing unit 103 supplies the output voltage of the DC power supply 101 to the motor device 1 by turning the switching elements Q11, Q12 ON and OFF, respectively, for the first certain period during the transmission processing of transmitting the communication signal S0 to the motor device 1. As can be seen, for the first certain period of the transmission processing, the DC voltage is applied continuously between the pair of input terminals 1A, 1B.

The processing unit 103 further has the capability of receiving the current signal S1 transmitted from the motor device 1 to the controller 10. It will be described in detail later in the “(2) Operation” section how the controller 10 receives the current signal S1.

The detection unit 107 detects a current flowing through the detection resistor R12 by detecting the voltage across the detection resistor R12. In this embodiment, when the controller 10 is connected to the motor device 1, the detection resistor R12 is electrically connected between a low-potential terminal of the DC power supply 101 and the low-potential input terminal 1B of the motor device 1. Also, if the motor device 1 generates the current signal S1 in the communication mode, the current flowing from the motor device 1 to the controller 10 flows through the detection resistor R12. That is to say, the detection unit 107 detects the current flowing from the motor device 1 to the controller 10 by the generation of the current signal S1.

In this embodiment, the detection unit 107 includes a low-pass filter including a resistor and a capacitor (i.e., an integration circuit). Thus, the detection unit 107 makes the low-pass filter calculate an integral of the current flowing through the detection resistor R12 and output the integral thus calculated to the processing unit 103.

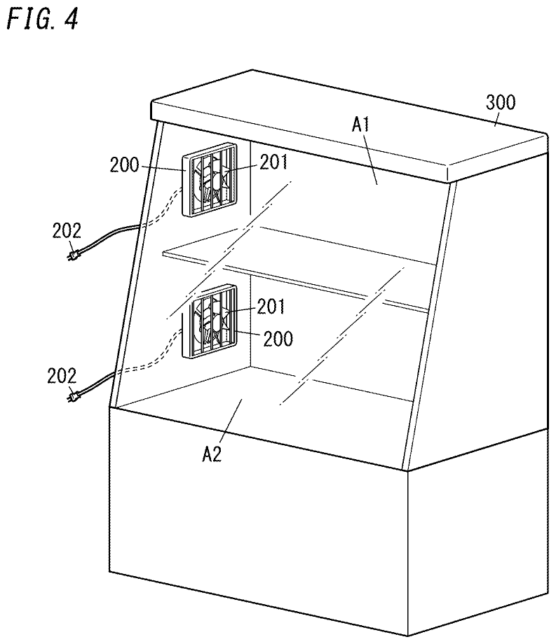

The motor device 1 according to this embodiment may be built in a fan unit 200 such as the ones shown in FIG. 4, for example. In FIG. 4, illustration of the motor device 1 is omitted. Each fan unit 200 includes the motor device 1, blades 201, and a power cable 202. The blades 201 are mounted on the rotational shaft of the motor 4 of the motor device 1 and turn as the motor 4 is driven. In other words, the fan unit 200 turns the blades 201 on receiving the force produced by the motor device 1. That is to say, when the motor device 1 is used in the fan unit 200, the load for the motor device 1 is the blades 201.

The fan unit 200 may be used as, for example, a cooling fan for business use, for example. In the example illustrated in FIG. 4, the fan units 200 are provided for a refrigerator showcase 300 with two (upper and lower) display spaces A1, A2. Specifically, two fan units 200 are respectively attached to a sidewall of the upper display space A1 and a sidewall of the lower display space A2.

Each fan unit 200 is electrically connected to the power supply AC1 by connecting the power cable 202 to an AC outlet. When connected to the power supply AC1, the motor device 1 of each fan unit 200 operates in the normal mode. That is to say, when connected to the power supply AC1, each fan unit 200 turns the blades 201 in accordance with the operation data that the processing unit 5 of the motor device 1 has. This allows the two fan units 200 to cool the display spaces A1, A2, respectively.

In addition, each fan unit 200 is also electrically connected to the controller 10 by connecting the power cable 202 to the controller 10. While connected to the controller 10, the motor device 1 of each fan unit 200 operates in the communication mode. That is to say, while connected to the controller 10, each fan unit 200 updates the operation data that the processing unit 5 of the motor device 1 has in accordance with the data or commands included in the communication signal S0 transmitted from the controller 10.

In this case, the two fan units 200 may update the operation data into two different sets by using the controller 10. For example, the operation data of the respective fan units 200 may be updated by the controller 10 such that the numbers of revolutions of the fan units 200 are high enough to cool the upper display space A1 to 5° C. and cool the lower display space A2 to 0° C. That is to say, when a plurality of fan units 200 are provided, the operation data may be updated on an individual basis by using the controller 10. Alternatively, the operation data of all fan units 200 may naturally be updated into a single set of operation data by using the controller 10.

(2) Operation

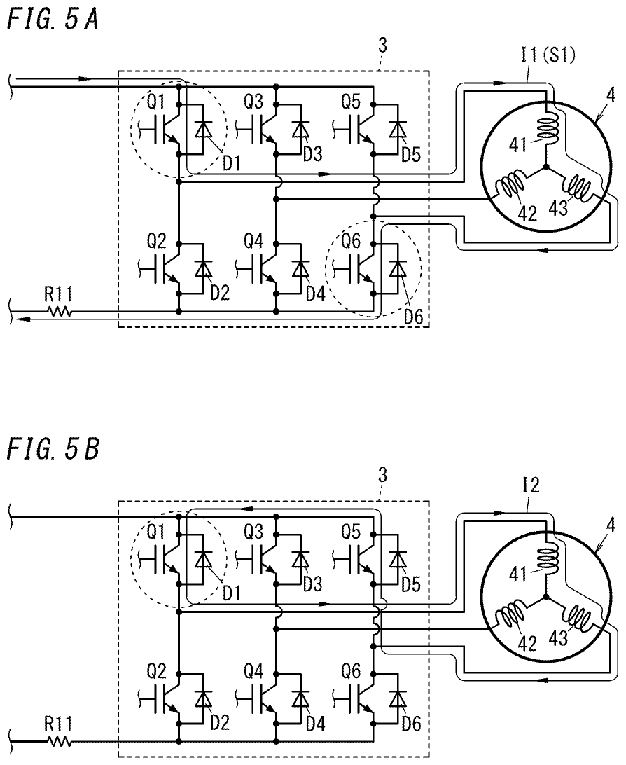

Next, it will be described with reference to FIGS. 5A-7C how the motor device 1 transmits the current signal S1 and how the controller 10 receives the current signal S1. In FIGS. 5A and 5B, the dotted circles indicate that the switching elements are in ON state.

First, it will be described how the motor device 1 transmits the current signal S1. The processing unit 5 of the motor device 1 generates the current signal S1 by controlling the driving unit 6 to switch the ON/OFF states of some of the switching elements Q1-Q6 of the inverter circuit 3 and thereby cause a current to flow through the windings 41, 42, 43. In this embodiment, for example, the processing unit 5 generates the current signal S1 by switching the ON/OFF states of the switching elements Q1, Q6 to cause a current to flow through the first winding 41 and the third winding 43.

Specifically, the processing unit 5 controls the driving unit 6 to turn the switching elements Q1, Q6 ON as shown in FIG. 5A. This causes a current I1 to flow along a path that passes through the switching element Q1, the first winding 41, the third winding 43, the switching element Q6, and the detection resistor R11 in this order. Then, the current I1 flows into the controller 10 via the input terminal 1B. That is to say, the current I1 corresponds to the current signal S1. As can be seen, according to this embodiment, the processing unit 5 generates the current signal S1 with the current allowed to flow in a single direction through the windings 41, 42, 43 (e.g., through the first winding 41 and the third winding 43 in this example).

In this case, if the amount of the current I1 is not large enough for the current signal S1, then it is difficult for the controller 10 to detect the current signal S1. Thus, the current needs to flow through the windings 41, 42, 43 (e.g., through the first winding 41 and the third winding 43 in this example) continuously until the amount of the current I1 becomes large enough. Nevertheless, a situation where an excessive current greater than a rated current flows through the windings 41, 42, 43 should be avoided.

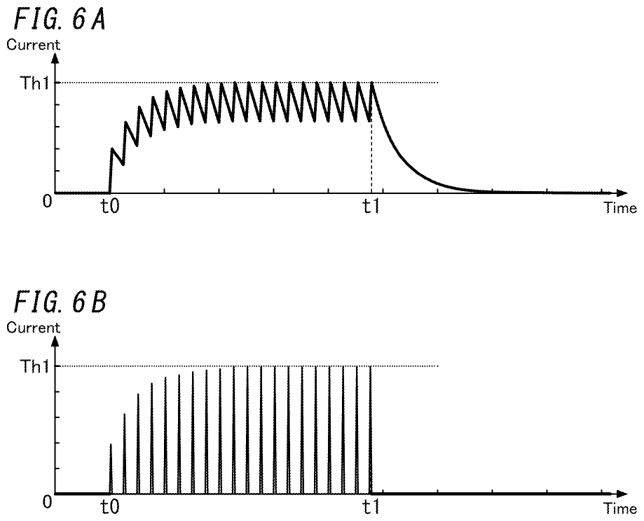

Thus, in this embodiment, the processing unit 5 detects the current I1 (i.e., the current flowing through the windings 41, 42, 43) by using the detection resistor R11 and controls the driving unit 6 to turn the switching element Q6 OFF when the amount of the current I1 reaches a predetermined current value Th1 (see FIG. 6A). As a result, the energy stored in the first winding 41 and the third winding 43 causes a current I2 to flow along a path that passes through the first winding 41, the third winding 43, the diode D5, and the switching element Q1 in this order as shown in FIG. 5B. In this state, the current I2 does not flow through the detection resistor R11. In other words, the current I1 does not flow in this state.

In this manner, the processing unit 5 controls the current I1 by switching the ON/OFF states of the switching element Q6 such that the state where the current I1 flows alternates with the state where the current I1 does not flow depending on the result of detection by the detection resistor R11. That is to say, the processing unit 5 controls the current flowing through the windings 41, 42, 43 by performing switching control on the switching elements Q1-Q6 (e.g., the switching elements Q1, Q6 in this example) that are electrically connected to the windings 41, 42, 43. This allows the current flowing through the windings 41, 42, 43 (e.g., the first winding 41 and the third winding 43 in this example) to be limited to the predetermined current value Th1 or less as shown in FIG. 6A. In the same way, the current flowing through the detection resistor R11 (i.e., the current I1) is limited to the predetermined current value Th1 or less as shown in FIG. 6B. That is to say, the processing unit 5 limits the current flowing through the windings 41, 42 , 43 to the predetermined current value Th1 or less.

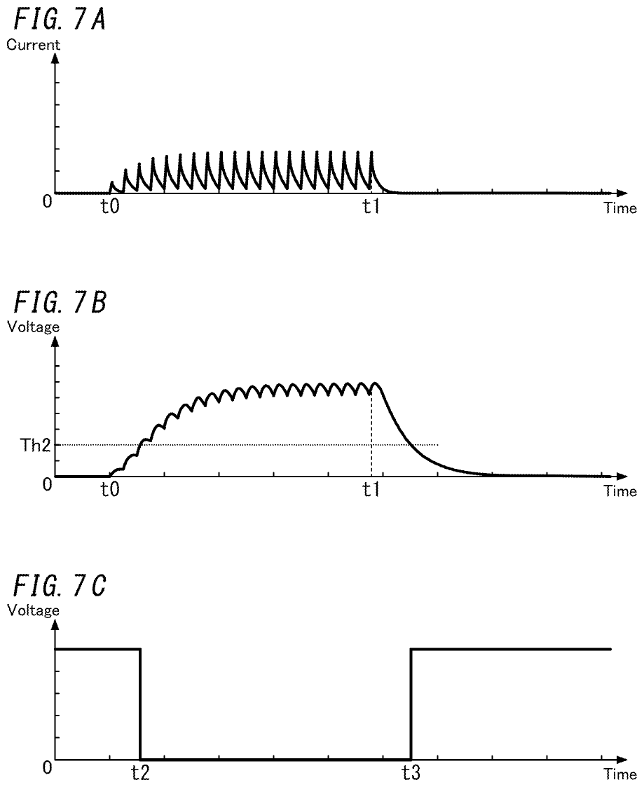

In FIGS. 6A and 6B, a time t0 is a point in time when the processing unit 5 starts performing the switching control, i.e., a point in time when the processing unit 5 starts transmitting the current signal S1. Also, in FIGS. 6A and 6B, a time t1 is a point in time when the processing unit 5 finishes performing the switching control, i.e., a point in time when the processing unit 5 finishes transmitting the current signal S1. The same statement applies to FIGS. 7A and 7B (to be referred to later) as well.

Next, it will be described how the controller 10 receives the current signal S1. The processing unit 5 generates the current signal S1 continuously from the time t0 through the time t1, thus causing a current with the waveform shown in FIG. 7A to flow through the detection resistor R12 of the controller 10. Making the detection unit 107 calculate an integral of this current allows a voltage signal with the waveform shown in FIG. 7B to be obtained.

Then, the processing unit 103 receives the current signal S1 based on the integral (i.e., voltage signal) provided by the detection unit 107. Specifically, the processing unit 103 compares the voltage of the voltage signal output from the detection unit 107 with a threshold value Th2, thereby converting the current signal S1 into a digital signal and acquiring the digital signal as shown in FIG. 7B. That is to say, if the voltage of the voltage signal output from the detection unit 107 is less than the threshold value Th2, the processing unit 103 receives the current signal S1 as a high-level digital signal. On the other hand, if the voltage of the voltage signal output from the detection unit 107 is greater than the threshold value Th2, the processing unit 103 receives the current signal S1 as a low-level digital signal. In the example illustrated in FIG. 7C, the processing unit 103 receives the current signal S1 that the motor device 1 has transmitted from the time t0 through the time t1 as a digital signal that has the low level from a time t2 (>to) through a time t3 (>t1).

The controller 10, which has received the current signal S1, notifies the user, by either showing the result of reception on its built-in display or emitting a voice message indicating the result of reception through its built-in loudspeaker, for example, that the current signal S1 has been received. This allows the user to confirm that the motor device 1 has received the communication signal S0 safely and has updated the operation data.

Next, advantages of the motor device 1 according to this embodiment will be described in comparison with a motor device according to a comparative example. The motor device according to the comparative example does not have the capability of transmitting the current signal S1, which is a major difference from the motor device 1 according to this embodiment. On receiving the communication signal S0 safely from the controller 10, the motor device according to the comparative example drives the motor, thereby turning a load connected to the motor (e.g., blades of a fan unit). Then, the user confirms, either by seeing the load turn or hearing vibration sound involved with the turn of the load, that the motor device according to the comparative example has received the communication signal S0 safely. That is to say, the motor device according to the comparative example provides the user with the information by turning the load.

However, if the motor device according to the comparative example and the load are installed in a place that is out of reach of the user's eyes, for example, then the motor device does not allow the user to see the load turn, which is a problem with the motor device according to the comparative example. In addition, if the motor device according to the comparative example and the load are installed in an environment with significant ambient noise, for example, then the motor device does not allow the user to hear the vibration sound involved with the turn of the load, which is another problem with the motor device according to the comparative example. Furthermore, if a test run of the load is not permitted, then the motor device according to the comparative example cannot turn the load, and therefore, cannot provide the user with information, which is still another problem with the motor according to the comparative example.

In contrast, the motor device 1 according to this embodiment is able to transmit the current signal S1 to the controller 10, which is connected to the motor device 1, by causing a current to flow through the windings 41, 42, 43 of the motor 4. That is to say, according to this embodiment, the motor device 1 is able to provide the controller 10 with information without turning the load connected to the motor 4. Thus, the motor device 1 according to this embodiment allows, even when the user cannot confirm the operation of the motor 4 either visually or aurally, him or her to gain the information provided by the motor device 1. In addition, even when a test run of the load is not permitted, the motor device 1 according to this embodiment is still able to provide the user with information by transmitting the current signal S1.

(3) Variations

Note that the embodiment described above is only one of various embodiments of the present disclosure and should not be construed as limiting. Rather, the embodiment described above may be readily modified in various manners depending on a design choice or any other factor without departing from the scope of the present disclosure. Optionally, the same functions as those of the motor device 1 may also be implemented as a communication method, a computer program, or a non-transitory storage medium on which the program is stored, for example.

A communication method according to an aspect is a method for establishing communication between the controller 10 and the motor device 1 including the motor 4. The communication method includes transmitting the current signal S1 to the controller 10, which is electrically connected to the motor 4, by causing a current to flow through the windings 41, 42, 43 of the motor 4.

Next, variations of the embodiment described above will be enumerated one after another. Note that the variations to be described below may be adopted in combination as appropriate.

The motor device 1 according to the present disclosure may include a computer system in the processing unit 5, for example. In that case, the computer system may include, as principal hardware components, a processor and a memory. The functions of the motor device 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some storage medium such as a memory card, an optical disc, or a hard disk drive, any of which is readable for the computer system. The processor of the computer system may be made up of a single or a plurality of electronic circuits including a semiconductor integrated circuit (IC) or a largescale integrated circuit (LSI). Those electronic circuits may be either integrated together on a single chip or distributed on multiple chips, whichever is appropriate. Those multiple chips may be integrated together in a single device or distributed in multiple devices without limitation.

In the embodiment described above, the processing unit 5 of the motor device 1 controls the inverter circuit 3 to transmit the current signal S1 to the controller 10 in response to the communication signal S0 transmitted from the controller 10. That is to say, in the embodiment described above, the data size of the current signal S1 corresponds to one bit. However, this is only an example of the present disclosure and should not be construed as limiting. Alternatively, the processing unit 5 may also transmit a current signal S1 including data of multiple bits by controlling the inverter circuit 3, for example. In other words, the processing unit 5 may transmit an asynchronous serial signal as the current signal S1 to the controller 10. That is to say, in that case, the communication established between the processing unit 5 and the controller 10 is asynchronous serial communication.

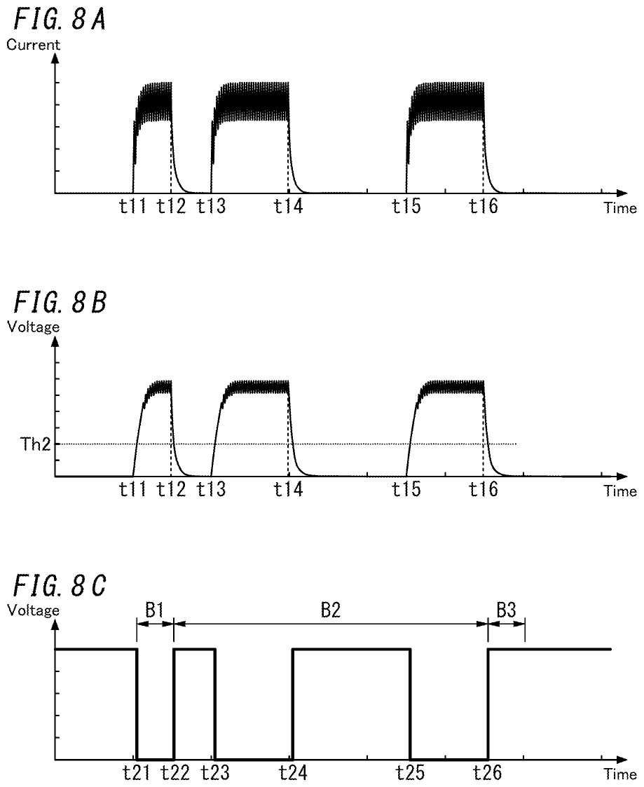

Next, it will be described with reference to FIGS. 8A-8C how the motor device 1 transmits a serial signal as the current signal S1 to the controller 10. In FIGS. 8A and 8B, the time t11 is a point in time when the processing unit 5 starts transmitting the current signal S1. Also, in FIGS. 8A and 8B, the time t16 is a point in time when the processing unit 5 finishes transmitting the current signal S1. In this example, the processing unit 5 generates the current signal S1 by causing a current to flow through the windings 41, 42, 43 intermittently during the period from the time t11 through the time t16. Specifically, the processing unit 5 performs switching control in each of a period from the time t11 through a time t12, a period from a time t13 through a time t14, and a period from a time t15 through the time t16. The detection unit 107 of the controller 10 outputs a voltage signal with the waveform shown in FIG. 8B by causing a current with the waveform shown in FIG. 6A to flow through the windings 41, 42, 43 (e.g., the first winding 41 and the third winding 43 in this case).

Then, the processing unit 103 of the controller 10 compares the voltage of the voltage signal output from the detection unit 107 with the threshold value Th2, thereby converting the current signal S1 into a digital signal and acquiring the digital signal. Specifically, the processing unit 103 receives the current signal S1 as a digital signal including a start bit B1, data B2 of 8 bits, and a stop bit B3 as shown in FIG. 8C. The start bit B1 is a digital signal that has the low level in a period from a time t21 (>t11) through a time t22 (>t12) and is represented by “L.” The data B2 is a digital signal that has the high level in a period from the time t22 through a time t23 (>t13) and in a period from a time t24 (>t14) through a time t25 (>t15) and is represented by “H, L, L, H, H, H, L, L.” The stop bit B3 is a digital signal that has the high level from a time t26 (>t16) on and is represented by “H.”

If the current signal S1 includes data of multiple bits as described above, an address to identify the motor device 1 may be included in the current signal S1. As the address, a serial number (product serial number) unique to the motor device 1 may be used, for example. According to this implementation, the controller 10 is able to identify the motor device 1 as the source of the current signal S1 by reference to the address included in the current signal S1. This implementation is effectively applicable to, for example, a situation where the single controller 10 is used to broadcast the communication signal S0 to multiple motor devices 1.

In the embodiment described above, the processing unit 5 of the motor device 1 changes the duty cycle of the switching element Q6 based on the result of detection obtained by the detection resistor R11. However, this is only an example of the present disclosure and should not be construed as limiting. Alternatively, the duty cycle of the switching element Q6 may also be a constant value.

Also, in the embodiment described above, the processing unit 5 of the motor device 1 generates the current signal S1 by controlling the ON/OFF states of the switching elements Q1, Q6 of the inverter circuit 3 to cause a current to flow through the windings 41, 43 of the motor 4. However, this is only an example of the present disclosure and should not be construed as limiting. Alternatively, the processing unit 5 may generate the current signal S1 by controlling the ON/OFF states of the switching elements Q2, Q3 of the inverter circuit 3 to cause a current to flow through the windings 41, 42 of the motor 4. Still alternatively, the processing unit 5 may also generate the current signal S1 by controlling the ON/OFF states of the switching elements Q4, Q5 of the inverter circuit 3 to cause a current to flow through the windings 42, 43 of the motor 4.

Furthermore, in the embodiment described above, the motor device 1 transmits the current signal S1 to the controller 10 in response to the communication signal S0 transmitted from the controller 10. However, this is only an example of the present disclosure and should not be construed as limiting. Alternatively, the motor device 1 may transmit the current signal S1 to the controller 10 spontaneously. Specifically, the processing unit 5 of the motor device 1 may monitor the output voltage of the reception unit 8 to determine whether or not the controller 10 is connected to the motor device 1. On detecting that the controller 10 is connected to the motor device 1, the processing unit 5 may transmit a current signal S1, including data about an error history stored in the memory, for example, to the controller 10 by controlling the inverter circuit 3.

In the embodiment described above, the processing unit 5 of the motor device 1 generates the current signal S1 by controlling the inverter circuit 3 to cause a current to flow through the windings 41, 42, 43. However, this is only an example of the present disclosure and should not be construed as limiting. Alternatively, the motor device 1 may also have an additional circuit to cause a current to flow through the windings 41, 42, 43 separately from the inverter circuit 3. In that case, the processing unit 5 may generate the current signal S1 by controlling the additional circuit to cause a current to flow through the windings 41, 42, 43.

Furthermore, in the embodiment described above, the motor device 1 is used to turn the blades 201 of the fan unit 200. However, this is only an example of the present disclosure and should not be construed as limiting the use of the motor device 1. That is to say, the motor device 1 just needs to be configured to drive a load attached to the motor 4 by driving the motor 4 in accordance with the operation data that the processing unit 5 has. Thus, the use of the motor device 1 is not limited to any particular type of load.

Furthermore, in the embodiment described above, the controller 10 transmits the communication signal S0 to the motor device 1 by serial communication through the pair of electric cables 91, 92 connected between the controller 10 and the motor device 1. However, this is only an example of the present disclosure and should not be construed as limiting. Alternatively, the controller 10 may also be configured to transmit the communication signal S0 to the motor device 1 through a different communications path (no matter whether the path is wired or wireless) without using the pair of electric cables 91, 92, for example.

Furthermore, in the embodiment described above, the motor 4 that the motor device 1 includes is a brushless DC motor. However, this is only an example of the present disclosure and should not be construed as limiting. Alternatively, the motor 4 may also be, for example, a three-phase induction motor, a single-phase induction motor, or any other type of motor. Also, the inverter circuit 3 and the driving unit 6 may also be replaced with different driver circuits as appropriate according to the type of the motor 4. Even so, the processing unit 5 may also generate the current signal S1 by controlling the driver circuits and causing a current to flow through the windings that the motor 4 has.

(Resume)

As can be seen from the foregoing description, a motor device (1) according to a first aspect includes a motor (4) and a processing unit (5) to control the motor (4). The processing unit (5) transmits a current signal (S1) to a controller (10), which is electrically connected to the motor (4), by causing a current to flow through a winding (41, 42, 43) of the motor (4).

This aspect allows, even when the user cannot confirm the operation of the motor (4) either visually or aurally, him or her to gain the information provided by the motor device (1).

A motor device (1) according to a second aspect, which may be implemented in conjunction with the first aspect, further includes an inverter circuit (3). The inverter circuit (3) transforms an input current into an alternating current and supplies the current to the windings (41, 42, 43). The processing unit (5) generates the current signal (S1) by controlling the inverter circuit (3) to cause the current to flow through the windings (41, 42, 43).

This aspect allows the current signal (S1) to be generated by using an existent inverter circuit (3) to drive the motor (4), thus achieving the advantage of making it almost unnecessary to change the design of the motor device (1).

In a motor device (1) according to a third aspect, which may be implemented in conjunction with the first or second aspect, the processing unit (5) generates the current signal (S1) with the current caused to flow through the windings (41, 42, 43) in a single direction.

This aspect achieves the advantage of generating the current signal (S1) through simpler control than a situation where a current is caused to flow bidirectionally through the winding (41, 42, 43). In addition, according to this aspect, the motor (4) does not rotate, thus achieving the advantage of allowing, even when a test run of a given load is not permitted, the user to be provided with information.

In a motor device (1) according to a fourth aspect, which may be implemented in conjunction with any one of the first to third aspects, the processing unit (5) transmits the current signal (S1) in response to a communication signal (S0) transmitted from the controller (10).

According to this aspect, the controller's (10) receiving the current signal (S1) allows the user of the controller (10) to learn that the communication signal (S0) has been transmitted to the motor device (1).

In a motor device (1) according to a fifth aspect, which may be implemented in conjunction with the fourth aspect, the processing unit (5) transmits the current signal (S1) when receiving the communication signal (S0) safely.

According to this aspect, the controller's (10) receiving the current signal (S1) allows the user of the controller (10) to learn that communication has been established successfully with the motor device (1).

In a motor device (1) according to a sixth aspect, which may be implemented in conjunction with any one of the first to fifth aspects, the processing unit (5) determines, in accordance with a waveform of voltage supplied to the motor device (1), whether or not to transmit the current signal (S1).

This aspect achieves the advantage of reducing the chances of the current signal (S1) being transmitted unintentionally when not the controller (10) but a power supply (AC1) is connected to the motor device (1).

In a motor device (1) according to a seventh aspect, which may be implemented in conjunction with any one of the first to sixth aspects, the processing unit (5) transmits an asynchronous serial signal as the current signal (S1) to the controller (10).

This aspect achieves the advantage of allowing various types of information collected by the motor device (1), such as the history of errors that have occurred in the motor device (1), to be transmitted to the controller (10).

In a motor device (1) according to an eighth aspect, which may be implemented in conjunction with any one of the first to seventh aspects, the processing unit (5) limits the current flowing through the windings (41, 42, 43) to a predetermined current value (Th1) or less.

This aspect achieves the advantage of reducing the chances of an excessive amount of current, larger than a rated current, flowing through the windings (41, 42, 43) when the motor device (1) communicates with the controller (10).

In a motor device (1) according to a ninth aspect, which may be implemented in conjunction with the eighth aspect, the processing unit (5) controls the current flowing through the windings (41, 42, 43) by performing switching control on a switching element (Q1-Q6) that is electrically connected to the windings (41, 42, 43).

This aspect achieves the advantage of making the amount of current flowing through the windings (41, 42, 43) controllable by performing as simple a control as switching control.

A controller (10) according to a tenth aspect is electrically connected to the motor device (1) according to any one of the first to ninth aspects and receives the current signal (S1) transmitted from the motor device (1).

This aspect allows, even when the user cannot confirm the operation of the motor (4) either visually or aurally, him or her to gain the information provided by the motor device (1).

A motor system (100) according to an eleventh aspect includes the motor device (1) according to any one of the first to ninth aspects and a controller (10). The controller (10) is electrically connected to the motor device (1) and receives the current signal (S1) transmitted from the motor device (1).

This aspect allows, even when the user cannot confirm the operation of the motor (4) either visually or aurally, him or her to gain the information provided by the motor device (1).

A fan unit (200) according to a twelfth aspect includes a blade (201) to be attached to the motor (4) of the motor device (1) according to any one of the first to ninth aspects and turns the blade (201) on receiving force produced by the motor (4).

According to this aspect, the blade (201) is connected as a load to the motor (4). Thus, this aspect allows, even when the user cannot confirm the operation of the motor (4) and the blade (201) either visually or aurally, him or her to gain the information provided by the motor device (1).

A communication method according to a thirteenth aspect is a method for establishing communication between a controller (10) and a motor device (1) including a motor (4). The communication method includes transmitting a current signal (S1) to a controller (10), which is electrically connected to the motor (4), by causing a current to flow through windings (41, 42, 43) of the motor (4).

This aspect allows, even when the user cannot confirm the operation of the motor (4) either visually or aurally, him or her to gain the information provided by the motor device (1).

Note that the constituent elements according to the second to ninth aspects are not essential constituent elements for the motor device (1) but may be omitted as appropriate.

### REFERENCE SIGNS LIST

1 Motor Device

3 Inverter Circuit

4 Motor

41, 42, 43 Winding

5 Processing Unit

10 Controller

100 Motor System

200 Fan Unit

201 Blade

Q1-Q6 Switching Element

S0 Communication Signal

S1 Current Signal

Th1 Predetermined Current Value

1. A motor device comprising:
a motor; and
a processing unit configured to control the motor,
the processing unit being configured to transmit a current signal to a controller, which is electrically connected to the motor, by causing a current to flow through windings of the motor.

2. The motor device of claim 1, further comprising an inverter circuit configured to transform an input current into an alternating current and supply the current to the windings, wherein
the processing unit is configured to generate the current signal by controlling the inverter circuit to cause the current to flow through the windings.

3. The motor device of claim 1, wherein
the processing unit is configured to generate the current signal with the current caused to flow through the windings in a single direction.

4. The motor device of claim 1, wherein
the processing unit is configured to transmit the current signal in response to a communication signal transmitted from the controller.

5. The motor device of claim 4, wherein
the processing unit is configured to transmit the current signal when receiving the communication signal safely.

6. The motor device of claim 1, wherein
the processing unit is configured to determine, in accordance with a waveform of voltage supplied to the motor device, whether or not to transmit the current signal.

7. The motor device of claim 1, wherein
the processing unit is configured to transmit an asynchronous serial signal as the current signal to the controller.

8. The motor device of claim 1, wherein
the processing unit is configured to limit the current flowing through the windings to a predetermined current value or less.

9. The motor device of claim 8, wherein
the processing unit is configured to control the current flowing through the windings by performing switching control on a switching element that is electrically connected to the windings.

10. A controller electrically connected to the motor device of claim 1 and configured to receive the current signal transmitted from the motor device.

11. A motor system comprising:
the motor device of claim 1; and
a controller electrically connected to the motor device and configured to receive the current signal transmitted from the motor device.

12. A fan unit comprising a blade to be attached to the motor of the motor device of claim 1 and configured to turn the blade on receiving force produced by the motor.

13. A method for establishing communication between a controller and a motor device including a motor,
the method comprising transmitting a current signal to a controller, which is electrically connected to the motor, by causing a current to flow through windings of the motor.

14. The motor device of claim 2, wherein
the processing unit is configured to generate the current signal with the current caused to flow through the windings in a single direction.

15. The motor device of claim 2, wherein
the processing unit is configured to transmit the current signal in response to a communication signal transmitted from the controller.

16. The motor device of claim 3, wherein
the processing unit is configured to transmit the current signal in response to a communication signal transmitted from the controller.

17. The motor device of claim 14, wherein
the processing unit is configured to transmit the current signal in response to a communication signal transmitted from the controller.
